(19) United States
(12) Patent Application Publication
(10) Pub. No.: US 2005/0164020 A1
(43) Pub. Date: Jul. 28, 2005

(54) Composite material with improved binding strength and method for forming the same

(75) Inventors: Masaru Seita, Kitaadachi-gun (JP); Hideki Tsuchida, Hasuda-shi (JP); Masaaki Imanari, Misato-shi (JP); Masaru Kusaka, Kitaadachi-gun (JP); Koichi Yomogida, Saitama-shi (JP); Hidemi Nawafune, Osaka (JP); Syozo Mizumoto, Kobe-shi (JP); Shingo Ikeda, Kobe-shi (JP)

Correspondence Address: S. Matthew Cairns;Edwards & Angell, LLP, P.O. Box 55874, Boston, MA, 02205, US

(73) Assignee: Shipley Company, L.L.C., Marlborough, MA (US)

(21) Appl. No.: 11/041,682

(22) Filed: Jan. 24, 2005

Related U.S. Application Data
(62) Division of application No. 10/034,775, filed on Dec. 27, 2001.

(30) Foreign Application Priority Data
Dec. 27, 2000 (JP) 2000-397489

(51) Int. Cl. B32B 15/08

(52) U.S. Cl. 428/461; 427/229; 427/372.2

(57) ABSTRACT

This invention offers a composite material with improved binding strength and a method for its manufacture. In particular, the invention offers a composite material having metal at the surface of a resin base, obtained by subjecting the surface of a resin base to an ion exchange group introduction treatment, treating the surface of said resin base with liquid containing metal ions, and then reducing said metal ions, where the aforementioned composite material resin is characterized in that the resin base and metal of said composite material are hot-pressed. Said composite material has superior binding strength between resin base and metal relative to composite materials obtained by electroless plating which have inferior binding strength between resin base and metal. Moreover, said composite material is readily manufactured because hot-press methods can be used in the formation of said composite material.

### TECHNOLOGICAL FIELD OF THE INVENTION

The present invention relates to a composite material having metal at the surface of a resin base, and a method for forming the aforementioned composite material.

### PRIOR ART

In plating treatments carried out on plastic resin bases or plating treatments carried out in semi-additive methods or through-hole plating methods used in printed wiring boards, electroless plating has been used as the method for forming a conductive coating on non-conducting resin. The binding strength between the resin base and metal coating is generally low in resin composite materials produced by using electroless plating to form metal coatings on resin bases.

In general, hot-pressing the two materials is considered to be a method for improving binding strength between resin bases and metal coatings. However, with resin composite materials formed by means of electroless plating treatments, the resin base surface can be damaged under the influence of electroless plating baths, and in particular, alkaline plating baths that are typically used for electroless copper plating baths. This damage causes separation of the metal coating during hot-pressing. Consequently, composite materials obtained by electroless plating treatments have not been subjected to hot-press treatments in the past, and thus composite materials with high binding strength between the resin base and metal have not been obtained.

### PROBLEMS TO BE SOLVED BY THE INVENTION

For this reason, a composite material that has a metal coating formed on a resin base and which has with improved binding strength between resin base and metal coating is in high demand.

The present invention was developed in light of this state of affairs, and has the objective of offering a composite material with metal at the surface of a resin base, which is obtained by hot-pressing said resin base and said metal, thereby improving the binding strength between said resin base and said metal.

### SUMMARY OF THE INVENTION

The present invention offers a composite material having metal at the surface of a resin base, obtained by subjecting the surface of a resin base to an ion exchange group introduction treatment, treating the surface of said resin base with liquid containing metal ions to introduce metal ions, and then reducing said metal ions, said composite material being characterized in that said composite material resin base and metal are hot-pressed.

In addition, the present invention offers a method for forming a composite material with improved binding strength between resin base and metal, which comprises (1) subjecting the resin base surface to an ion exchange group introduction treatment, (2) treating the surface of said resin base with a liquid containing metal ions in order to introduce the metal ions, (3) reducing said metal ions to form and a composite material having metal at the surface of the resin base, and (4), hot-pressing the metal and resin base of said composite material.

### BRIEF DESCRIPTION OF THE DRAWINGS

FIG. 1 is a graph showing the relationship between hot-press temperature represented on the horizontal axis and binding strength represented on the vertical axis.

FIG. 2 is a graph showing the relationship between hot-press pressure represented on the horizontal axis and binding strength represented on the vertical axis.

### DETAILED DESCRIPTION OF THE INVENTION

The present invention offers a composite material having metal at the surface of a resin base, obtained by subjecting the surface of a resin base to an ion exchange group introduction treatment, treating the surface of said resin base with a liquid containing metal ions to introduce metal ions, and then reducing said metal ions, said composite material being characterized in that said composite material resin base and metal are hot-pressed. The present invention is described below.

The resin base that can be used in the composite material of the present invention can be any resin, provided that it can withstand the hot-press treatment described below, and has appropriate physical properties relative to the objectives of use, for example, good strength and corrosion resistance. The resin base can have any shape, without any particular restrictions. In addition, the resin base that can be used in the present invention is not restricted to resin moldings, as composite materials can also be used that are produced by introducing reinforcing material such as glass fiber within the resin. Alternatively, materials produced by coating resins onto bases composed of various elements such as metals can also be used.

Any resin can be used for the resin base, and examples include high-density polyethylene, medium-density polyethylene, branched low-density polyethylene, linear low-density polyethylene, ultra-high-molecular-weight polyethylene and other polyethylene resins, polypropylene resin, polybutadiene, polybutene resin, polybutylene resin, polystyrene resin and other polyolefin resins; polyvinyl chloride resin, polyvinylidene chloride resin, polyvinylidene chloride-vinyl chloride copolymer resin, polyethylene chloride, polypropylene, chloride, tetrafluoroethylene and other halogenated resins; AS resin; ABS resin; MBS resin; polyvinyl alcohol resin; polymethyl acrylate and other polyacrylate ester resins; polymethyl methacrylate and other polymethacrylate ester resins; methyl methacrylate-styrene copolymer resins; maleic anhydride-styrene copolymer resins; polyvinyl acetate resins; cellulose propionate resins, cellulose acetate resins and other cellulose resins; epoxy resin; polyimide resin; nylon and other polyamide resins; polyamidoimide resins; polyarylate resin; polyether imide resin; polyester ether ketone resin; polyethylene oxide resin; PET resin and various other polyester resins; polycarbonate resin; polysulfone resin; polyvinyl ether resin; polyvinyl butyral resin; polyphenylene oxide and other polyphenylene ether resins; polyphenylene sulfide resin; polybutylene terephthalate resin; polymethylpentene resin; polyacetal resin; vinyl chloride-vinyl acetate copolymer; ethylene-vinyl acetate copolymer; ethylene vinyl chloride copolymer; and other copolymer and blended thermoplastic resins, epoxy resin; xylene resin; guanamine resin; diallylphthalate resin; vinyl ester resin; phenol resin; unsaturated polyester resin; furan resin; polyimide resin; polyurethane resin; maleic acid resin; melamine resin; urea resin; and other thermosetting resins, as well as mixtures thereof. However, examples are not restricted to these.

Preferred resins are epoxy resin, polyimide resin, vinyl resin, phenol resin, nylon resin, polyphenylene ether resin, polypropylene resin, fluorine-based resin and ABS resin, with preferred examples being epoxy resin, polyimide resin, polyphenylene ether resin, fluorine-based resin and ABS resin, with epoxy resin and polyimide resin being additionally desirable. The resin base can be composed of individual resins, or can be composed of multiple resins. In addition, the surface that is treated with ion exchange group introduction agent need not be the resin base, as the base can be a composite formed by applying or laminating a resin onto another base.

The metal that is introduced into the resin base in the composite material of the present invention can be a metal composed of an individual metal element, or an alloy composed of two or more metal elements. In regard to the metal, the aforementioned alloy can take various forms, e.g., forms in which multiple metal elements form a solid solution, forms in which a non-crystalline body is formed from a mixed body of component metals comprising various metal elements, or forms in which these are combined. Examples of said metal include metals selected from a group comprising the metals Sc, Ti, V, Cr, Mn, Fe, Co, Ni, Cu, Zn, Ga, Ge, As, Se, Y, Zr, Nb, Mo, Tc, Ru, Rh, Pd, Ag, Cd, In, Sb, Te, Hf, Ta, W, Re, Os, Ir, Pt, Au, Hg, Tl, Pb, Bi, Po and alloys thereof Preferred metals are those selected from the metals V, Cr, Mn, Fe, Co, Ni, Cu, Ga, As, Se, Mo, Ru, Rh, Pd, Ag, Cd, In, Sb, Te, Os, k, Pt, Au, Hg, Pb, Bi and alloys thereof. Additionally desirable metals are those selected from a group comprising the metals V, Mn, Co, Ni, Cu, Ga, As, Se, Mo, Pd, Ag, In, Sb, Te, Pt, Au, Hg, Bi and alloys thereof. The most preferred metals are those selected from a group comprising the metals Co, Ni, Cu, Pd, Ag, Pt, Au and alloys thereof.

The metal that is introduced into the resin base in the composite material of the present invention can be present in any form on the base. For example, the metal can be present as fine grains isolated from each other on the substrate surface, or can be a material that forms a coating or network structures, or combinations thereof. Various configurations can be determined appropriately, such as the particle diameter and particle distribution when the material is a particulate, or the coating thickness when a coating is formed. The mode of introduction of the component containing metal elements can be adjusted appropriately depending on whether each of the processes is repeated a number of times, and depending on changes in the various conditions of the process (1) wherein the surface of the resin base is subjected to the ion exchange group introduction treatment, the process (2) wherein metal ions are introduced by treating the surface of said resin base with liquid containing metal ions, and the process (3) wherein said metal ions are reduced and a composite material is formed that has a metal at the surface of the resin base.

The surface of the composite material formed by the introduction of metal on the resin base has various useful characteristics such as conductivity, semiconductor properties, magnetic properties and non-charging properties in accordance with the type, amount and introduction mode of the metal that is contained. In addition, when the metal forms a coating, the material has various useful characteristics as a conductive coating, semiconductor coating, or magnetic coating in accordance with the type of the metal, or in accordance with the condition of the alloy if the metal is an alloy. From the standpoint of utility as a magnetic coating, it is preferable for the metal coating to comprise alloys such as Co—Ni, Co—Cr, Co—V, Ni—Mo—Fe, Gd—Co, Mn—Bi, Mn—Cu—Bi, Pt—Co or Co—Cr.

In the present invention, the aforementioned metal and the aforementioned resin that are used in the resin base can be freely selected. When the component containing metal element is a metal, the combination of metal and resin preferably comprises a resin selected from a group comprising epoxy resin, polyimide resin, vinyl resin, phenol resin, nylon resin, polyphenylene ether resin, polypropylene resin, fluorine-based resin or ABS resin and mixtures thereof for the resin, and a metal selected from a group comprising V, Mn, Co, Ni, Cu, Ga, As, Se, Mo, Pd, Ag, In, Sb, Te, Pt, Au, Hg, Bi and alloys thereof for the metal. It is additionally desirable for the resin to be a resin selected from a group comprising epoxy resin, polyimide resin, vinyl resin, phenol resin, nylon resin, polyphenylene ether resin, polypropylene resin, ABS resin and mixtures thereof, and for the metal to be a metal selected from a group comprising V, Mn, Co, Ni, Cu, Ga, As, Se, Mo, Pd, Ag, In, Sb, Te, Pt, Au, Hg, Bi and alloys thereof. It is further desirable for the resin to be a resin selected from a group comprising epoxy resin, polyimide resin, polyphenylene ether resin, ABS resin and mixtures thereof, and for the metal to be a metal selected from a group comprising V, Mn, Co, Ni, Cu, Ga, As, Se, Mo, Pd, Ag, In, Sb, Te, Pt, Au, Hg, Bi and alloys thereof.

In the composite material of the present invention, the binding strength between the resin base and metal is improved. The term “binding strength” used in this specification refers to the binding strength measured by the peel strength measurement method. Specifically, a copper coating of 10-30 μm is formed by copper sulfate plating on the metal of the composite material of the present invention, and after annealing for 1 h at 120° C., the value is measured by a test (90° peel strength test) wherein said copper coating is cut at a width of 1 cm, and a tensile testers is used in order to pull the coating perpendicularly at a rate of 30 mm/min.

The binding strength between the resin base and metal in the composite material of the present invention will vary depending on the binding strength prior to hot-pressing, but in general, the value is 1 N/cm or greater, with 5 N/cm or greater being preferred, 8 N/cm or greater being additionally desirable, and 10 N/cm or greater being even more desirable. The binding strength of the composite material of the present invention prior to hot-pressing is generally about 1-5 N/cm. The binding strength of the composite material obtained by electroless plating treatment is generally less than 1 N/cm.

The composite material of the present invention, as described below, is characterized in that the surface of the resin base is subjected to an ion exchange group introduction treatment, the surface of said resin base is then treated with a liquid containing metal ions to introduce metal ions, whereupon said metal ions are reduced. Thus, the material does not have a catalyst layer between the metal and resin base. When a metal coating is formed on the resin base surface by an electroless plating method, first, the resin base is treated with catalyst composed of Pd and Sn or Cu, thereby forming catalyst nuclei composed of Pd and tin salt or Cu, whereupon the plating metal is deposited with said catalyst nuclei as centers, thus forming the metal coating. In this case, the catalyst layer refers to the layer of catalyst formed on the resin base. It is not necessary for said catalyst to be present in layer form; rather, the catalyst nuclei at the resin surface can be present as isolated points, provided that the catalyst is present on the resin. Consequently, the composite material having the metal coating on the resin base surface obtained by means of an electroless plating method has catalyst nuclei between said resin base and metal coating. In other words, the material has a catalyst layer. On the other hand, in contrast to materials formed by conventional electroless plating, the composite material of the present invention is a material that has no catalyst layer between the resin base and the component containing metal element.

In the composite material of the present invention, the metal that is introduced onto the resin base is present with a more uniform distribution relative to cases where metal is introduced by conventional electroless plating. In addition, when the metal forms a coating, it has a more uniform film thickness relative to composite materials having metal coatings formed by conventional electroless thin film plating. Although a theoretical grasp cannot be expected, the aforementioned advantage of the present invention is thought to result from the fact that the composite material of the present invention does not have a catalyst layer. Specifically, because metal is deposited around catalyst nuclei formed on the resin base in electroless plating, the areas around the catalyst nuclei are thick, and the areas where catalyst nuclei are not present are thin, in terms of the film thickness of the resulting metal coating. Because the distribution of catalyst nuclei in electroless plating is not uniform, sufficiently uniform film thickness is not obtained for film thicknesses of 200 nm or less when the distribution density is low. As a result, it is impossible to control film thickness. On the other hand, the composite material of the present invention does not involve the deposition of metal around catalyst nuclei, and so film thickness non-uniformity resulting from electroless plating techniques does not occur.

The composite material of the present invention can be manufactured by a composite material formation method, which comprises (1) subjecting the surface of the resin base to an ion exchange group introduction treatment, (2) treating the surface of said resin base with a liquid containing metal ions to introduce metal ions, (3) reducing said metal ions to form a composite material with metal at the surface of the resin base, and (4) hot-pressing the metal and resin base of said composite material. These various processes are described in detail below.

Process 1: In the process wherein an ion exchange group introduction treatment is carried out at resin base surface, the resin base is first subjected to an ion exchange group introduction treatment in order to introduce groups having ion exchange capacity into the resin base.

In the present invention, the groups having ion exchange capacity that are introduced by the ion exchange group introduction treatment can be cation exchange groups or anion exchange groups. Examples include carboxyl groups, thiocarboxyl groups, dithiocarboxyl groups, sulfo groups (sulfonic acid groups), sulfino groups, sulfeno groups, haloformyl groups, carbamoyl groups, hydrazinocarbonyl groups, amidino groups, cyano groups, nitrilo groups, isocyan groups, cyanato groups, isocyanato groups, thiocyanato groups, isothiacyanato groups, formyl groups, hydroxyl groups, carboxyl groups, thioformyl groups, thioxo groups, mercapto groups, hydropyroxyl groups, amino groups, imino groups, hydrazino groups, diazo groups, azido groups, nitro groups and nitroso groups, but groups are not restricted to these. It is preferable for the groups having ion exchange capacity to be carboxyl groups, hydroxyl groups, carbonyl groups, amino groups, imino groups, cyano groups and nitro groups. With cation exchange groups, ion exchange occurs with cationic metal ions in process (2), and with anion exchange groups, ion exchange occurs with anionic metals in process (2).

Examples of ion exchange group introduction treatments pertaining to the present invention that can be cited are plasma treatment and ion exchange group introduction agent treatment. Plasma treatment or ion exchange group introduction agent treatment can be used for the treatment, or both treatments can be carried out. When both treatments are carried out, the order of the treatments does not matter.

When the ion exchange group introduction treatment is a plasma treatment, said treatment effects the resin base by causing surface roughening due to etching or release of elements constituting the resin (hydrogen extraction, etc.) due to the high-energy active species, and due to branching/cross-linking or de-saturation, as well as the introduction of groups having ion exchange capacity.

Examples of groups having ion exchange capacity that are introduced by the plasma treatment include oxygen-containing functional groups such as carboxyl groups, hydroxyl groups and carbonyl groups for oxygen plasma or air, nitrogen-containing functional groups such as amino groups, imino groups and cyano groups for ammonia or nitrogen and hydrogen mixed gas plasmas, and functional groups such as nitro groups for nitrogen gas plasma, but examples are not restricted to these. In addition, it is possible to introduce various types of groups having ion exchange capacity using gases other than those mentioned above. Because groups having ion exchange capacity are introduced at the resin surface by means of the plasma treatment, most of the resin base surface is rendered hydrophilic.

The plasma treatment can be any treatment method, provided that metal can be appropriately introduced at the base resin. Examples that can be cited include low-pressure plasma treatments and normal-pressure plasma treatments, but there are no specific restrictions. Normal-pressure plasma treatments (in air, normal pressures (about 1 atm)) are preferred because they allow the treatment of large-size resin bases and allow continuous treatment. Any device can be used for the device whereby the plasma treatment is. carried out, and for example, a low-pressure plasma treatment device or other such device can be used. The treatment conditions are set appropriately in accordance with the type, etc., of resin base that is used and the coating containing metal element that is to be formed. The treatment conditions in the low-pressure plasma treatment are preferably a discharge current of 30-200 mA at 20 kHz, a pressure of 0.1-0.3 Pa, a treatment time of 1-30 min, and a reforming reagent such as oxygen, argon, CO₂ or N₂. More preferably, the discharge current is 50-150 mA at 20 kHz, the pressure is 0.1-0.3 Pa, the treatment time is 10-20 min, and the reforming reagent is oxygen, argon, CO₂ or N₂. On the other hand, treatment conditions for normal-pressure plasma treatment are preferably a pulse voltage of 70-100 kV, a discharge space of 1-3 cm and a treatment time of 0.5-100 min. More preferably, the pulse voltage is 80-90 kV, the discharge space is 1-2 cm and the treatment time is 1-30 min. In addition, the treatment temperature for the plasma treatment can be determined appropriately, but normal temperatures (about 20-30° C.) are preferred from the standpoint of resin base stability and workability. The gas in the atmosphere at the time of the plasma treatment can be H, N, O, N₂, O₂, O₃, etc., but oxygen is preferred for normal pressure.

Various methods can be used, without particular restrictions, for the method for introducing groups having ion exchange capacity at the surface of the resin base by means of the plasma treatment. For example, a method can be used wherein introduction is carried out by an appropriate well-known plasma treatment selected in accordance with the type of groups that are to be introduced and the resin that is used. Examples of methods for introducing carboxyl groups as acidic groups are presented below. After placing a polyimide resin film on a turn-table in a microwave low-temperature oxygen plasma treatment chamber, the evacuation pump is operated and the interior of the treatment chamber is evacuated to 0.13 Pa or less. Subsequently, with the vacuum pump operating, oxygen gas is introduced at a rate of 10 mL/min, and the polyimide resin is irradiated for 5 min at a discharge current of 50 (mA), thereby forming carboxyl groups as cation exchange groups at the resin surface. Alternatively, the polyimide resin can be subjected to a high pulse voltage of 70-100 kV in a narrow space of about 1 cm, and treatment can be carried out for 1 min to form carboxyl cation exchange groups at the resin surface.

The ion exchange group introduction agent treatment which is another mode for introducing ion exchange groups is carried out by bringing resin base into contact with ion exchange group introduction agent. The contact method and time, as well as the contact temperature, are determined appropriately so that groups having ion exchange capacity are introduced into the resin base in the desired amount, and so that the resin base is not damaged. An example of a contact method is immersion, but examples are not restricted to this. In process (1) of the present invention, treatment with ion exchange group introduction agent is carried out. Said treatment can be carried out one time, or multiple treatments can be carried out using the same or different introduction agents.

The ion exchange group introduction agent pertaining to the present invention includes any chemical agent that can introduce groups having ion exchange capacity into the resin base. Lewis acids and Lewis bases are preferred, but examples are not limited to these. Preferred examples of ion exchange group introduction agents are sulfuric acid, fuming sulfuric acid, sulfur trioxide, chlorosulfuric acid, sulfuryl chloride and other sulfonation agents, hydrochloric acid, nitric acid, acetic acid, formic acid, citric acid, lactic acid and other acids, sodium hydroxide, potassium hydroxide, ammonia and other alkalis, and amination agents, nitration agents, cyanation agents and oxidation agents. Sulfuric acid, potassium hydroxide and sodium hydroxide are additionally desirable.

When sulfuric acid is used as the ion exchange group introduction agent, the concentration of introduction agent is generally 5-17.5 M, with a concentration of 15-17 M being preferred. If the concentration is less than 5 M, time will be required for treatment, which is undesirable. On the other hand, if the concentration exceeds 17.5 M, the reaction with respect to non-conductive material will be vigorous, and the material structure will be greatly modified, which is undesirable. The treatment temperature is generally 20-90° C., with 40-70° C. being preferred. The treatment time is ordinarily 30 sec to 30 min, with 2 min to 20 min being preferred.

In addition, when an alkali solution such as aqueous solution of potassium hydroxide or sodium hydroxide is used as ion exchange group introduction agent, the concentration of the alkali solution is 0.1-10 M, with 1-5 M being preferred. If this concentration is 10 M or greater, the resin base will be too strongly attacked, and degradation of the resin base will readily occur. The solvent used for alkali treatment can be water or alcohol. The treatment temperature is 10-80° C., with 25-50° C. being preferred. The treatment time is 30 sec to 10 min, with 2-5 min being preferred. When alcohol is used as solvent, the same effect as when water is used as solvent can be obtained but at a lower alkali concentration, lower temperature and/or shorter times.

Process (2): In the process whereby metal ions are introduced by treating the surface of said base material with liquid containing metal ions, the resin base that has been subjected to the ion exchange group introduction treatment in process (1) above is treated with liquid containing metal ions. By means of this treatment, it is thought that groups having a capacity for ion exchange introduced at the resin base surface in process (1) undergo an ion exchange reaction with metal ions, and metal ions are thereby introduced.

A solution in which the metal element that constitutes the component containing the target metal element is present as metal ions may be used for the liquid containing metal ions. For example, when a metal is to be formed, a solution that contains the desired metal ions is sufficient, and when an alloy is formed, a solution can be used that contains the metal ions of all or some of the metal components that constitute the alloy. For alloys, when a solution is used that contains the metal ions of some of the metal components that constitute the alloy in process (2), it is possible to convert the material to the desired alloy by subsequent treatment with a solution containing the other metal components in process (3). In addition, when a component containing metal compound such as metal oxide or metal sulfide is to be formed, a solution that contains the metal ions of the metal component contained in said metal compound may be used. In addition, when component containing metal compound such as metal oxide or metal sulfide is to be formed, a liquid can be used that contains metal ions of the metal component contained in said metal compound.

The metal ions may be complex ions in solution, and in such a case, the complex ions can be any complex anion or complex cation. The liquid containing metal ions is generally used as an aqueous solution. However, depending on the metal ions that are used, the medium can be methanol or other organic solvent, or an organic mixed solvent medium composed of water and organic medium. As necessary, stabilizer for maintaining pH or complexing agent for preventing sedimentation of metal ions can also be blended in the liquid containing metal ions.

The metal element ions cited above can be cited as metal ions contained in the liquid containing metal ions used in the present invention.

In general, the metal ions are blended in the liquid containing metal ions in the form of metal compound or metal salt. There are no particular restrictions on the type of metal salt or metal compound that is used, and an appropriate soluble metal compound or metal salt can be used in accordance with the type of metal. Appropriate examples that can be cited include formate, acetate, chloroacetate, oxalate and other carboxylates, sulfate, sulfite, thiosulfate, fluoride, chloride, bromide, iodide, nitrate, nitrite, bicarbonate, hydroxide, phosphate, phosphite, pyrophosphate, metaphosphate, selenate, thiocyanate, tetrafluoroborate, trisethylenediamine chloride, cyanide, chlorate, perchlorate, formate, perbromate, iodate and periodate. Preferred substances are sulfate, chloride and nitrate, with sulfate being preferred.

The appropriate concentration of metal ion in the liquid containing metal ions is ordinarily about 0.01-1 mol/L, with about 0.03-0.1 mol/L being preferred. In addition, when the target metal coating is in the form of an alloy containing numerous metal components, a solution can be used wherein metal ions are contained at molar ratios that correspond to the molar ratios in the metal component of the final molding. In this case, the total concentration of these multiple metal ions should be such that the aforementioned ranges are satisfied.

The method for treating the resin base with solution containing metal ions has no particular restrictions, and ordinarily, it is preferable to immerse the resin base that has been subjected to the plasma treatment in process (1) into the liquid containing metal ions. This treatment is carried out, for example, at a temperature of about 20-80° C., with about 25-60° C. being preferred, and for a period of about 1-10 min, with about 3-5 min being preferred. In addition, after treating the resin base with liquid containing metal ions, the material can be washed with water as necessary and subjected to drying or other treatments.

In process (3) that is carried out after treatment with liquid containing metal ions, the pH of the liquid containing metal ions decreases. In order to replenish the liquid with hydroxide ions, the pH of the liquid containing metal ions is appropriately adjusted to a weakly acidic to neutral range, and specifically, a pH of about 2-6, with about 3-4 being preferred.

Process 3: In the process in which the composite resin having metal at the surface of a resin base is formed by reduction of said metal ions, metal is introduced at the surface of the resin base by means of performing a reduction treatment on the metal ions that have been introduced in process (2) above. Said reduction treatment method has no particular restrictions, and can be any method, provided that it can achieve metallization by the reduction of metal ions that have been introduced at the resin base surface by the treatment of process (2). Ordinarily, the treatment is carried out by a method involving the immersion of the resin base treated in process (2) into a solution containing reducing agent.

There are no particular restrictions on the reducing agent used in reduction of the metal ions that have been introduced at the resin base surface, provided that the substance can cause the deposition of metal via the reduction of said metal ions. Ordinarily, the solution containing reducing agent can be used in the form of an aqueous solution. Examples of reducing agents used in this case that can be cited include sodium borohydride, dimethylaminoborane (DMAB), triiethylaminoborane (TMAB), hydrazine, formaldehyde and derivatives of these various compounds, sodium sulfite and other sulfites, and sodium hypophosphate and other hypophosphites. Any conventional reducing agent can be used, however, and substances are not restricted to these. The concentration of reducing agent in the aqueous solution is ordinarily about 0.0025-3 mol/L, with about 0.01-1.5 mol/L being preferred. The reducing temperature is ordinarily about 20-90° C., with about 25-80° C. being preferred, and the treatment time is about 1-60 min, with about 20-40 min being preferred.

Substances that can be used as reducing agents are selenium urea, arsenite, antimony (III) chloride and tellurium chloride, and when these reducing agents are used in the reduction of metal ions that have adsorbed chemically to the acidic groups, reduced metal component or alloy can be formed; specifically, Se when selenium urea is used, As when arsenite is used, Sb when antimony (III) chloride is used, or Te when tellurium chloride is used, is reduced to form a metal component and metal compound. The conditions of use of reducing agent such as selenium urea and arsenite can be the same as when the above various reducing agents are used, and these can be used in conjunction with the aforementioned various reducing agents. In particular, when selenium urea is used in conjunction with other reducing agents, the stability of selenium urea in the reducing agent solution can be improved. Using selenium urea in conjunction with other reducing agents is thus preferred.

With the reduction treatment carried out using the aqueous solution containing the aforementioned reducing agent, when sufficient metallization is difficult, a reducing treatment can be carried out using organic solvent solution containing reducing agent with stronger reducing capacity. Examples of reducing agents that can be used with organic solvents include metallic Li, Na and K (solvent: liquid ammonia, amines, etc.), trialkylaluminum (solvent: dioxane, toluene, tetrahydrofuran, etc.) and tri-n-butyltin and other tin hydride compounds (solvent: ethylene-based solvent, benzene, toluene, etc.). When the reducing treatment is carried out using organic solvent solutions of these reducing agents, it is desirable to determine the reducing agent concentration and reduction conditions appropriately in order to perform sufficient metallization in accordance with the type of metal salts that are to be reduced.

The reduction treatment can be carried out by irradiating the resin base having introduced metal ions with electromagnetic radiation. The reduction treatment carried out by electromagnetic radiation is a process in which electromagnetic excitation energy is utilized for the reduction reaction so that the metal is deposited from the metal ions that have been introduced. Any type of electromagnetic energy can be used for the electromagnetic radiation used for the reduction treatment, provided that it has excitation energy that can bring about the reduction of metal ions. However, ultraviolet radiation is preferred. The power of the electromagnetic radiation can be between 10 W and 10 kW, but in order to reduce treatment time, 100 W to 1 kW is preferred. The electromagnetic radiation irradiation time is 30 sec to 1 h, with 1 min to 10 min being preferred.

As necessary, irradiation with ultraviolet radiation can be carried out after mounting a glass mask. When a glass mask is mounted, the metal ions can be selectively reduced in only the desired regions (circuits). Any type of mask can used, provided that it does not allow passage of ultraviolet radiation. In addition, unreduced metal ions can be readily removed by a dilute nitric acid solution in regions other than the required regions. By this means, a composite material having a patterned metal coating can be formed directly on the resin base surface without carrying out electroless plating.

The various process (1)-(3) above can be carried out once, or any of the processes can be repeated any desired number of times. For example, the amount of metal introduced can be increased by repeating processes (2) and (3).

Process (4): In the process whereby the metal and resin base of said composite material is hot-pressed, the binding strength between the metal and resin base in said composite material can be improved by means of hot-pressing the composite material formed in process (3) above. The method for said reduction treatment used in hot-pressing has no particular restrictions, and any device can be used, provided that it can apply the required heat and pressure for hot-pressing. An example is the MHPCV750-5-200 device manufactured by Nakiseisakusho, but examples are not restricted.

The hot-press conditions can be set appropriately in accordance with the type, thickness and form of the metal, and the resin base in the composite material, as well as the desired binding strength for the composite material. However, a temperature of 100-300° C., a pressure of 490-2450 N/cm² and a time of 5-30 min are generally used. The hot-press conditions are preferably a temperature of 200-300° C., a pressure of 980-2450 N/cm² and a time of 10-30 min, and are more preferably a temperature of 250-300° C., a pressure of 1960-2450 N/cm² and a time of 20-30 min.

The method for forming the composite material with improved binding strength between the resin base and-metal of the present invention can include a process in which the composite material is subjected to a plating treatment. The plating treatment can be carried out after process (3) described above, and/or after process (4). Specifically, when carried out after process (3), the material that is subjected to the plating treatment is the composite material that has not been hot-pressed, whereas when the treatment is carried out after process (4), the material that is subjected to the plating treatment is the hot-pressed composite material.

Examples of said plating treatment include electrolytic metal plating, electroless melt plating and substitution metal plating, and any desired amount of any metal can be deposited by using any plating treatment. Multiple plating treatments can also be carried out. By means of said plating treatment, the composite material of the present invention can be formed from resin base and not just one, but more than one, plated metal layers.

The composite material with improved binding strength between the resin base and metal of the present invention is particularly useful in applications in which high binding strength is desired, for example, copper-clad laminated boards, TAB (tape automated bonding), FPCs (flexible printed circuits) and CSPs (chip size packages), but examples are not restricted to these, as the material can be used in any application in which composite materials comprising resin base and metal are used.

The present invention is described below by means of working examples, but said working examples do not limit the scope of the present invention.

### WORKING EXAMPLES

Peel Strength Measurement Method

After forming a thin film containing metal component by means of the method of the present invention, a 10-30 μm copper coating is formed by copper sulfate plating. After annealing for 1 h at 120° C., the coating is cut to a width of 1 cm, and a test (90° peel strength test) is carried out using a tensile tester to peel the coating perpendicularly at a rate of 30 mm/min.

Copper Sulfate Plating Treatment

A copper sulfate plating treatment was carried out on a composite material using the copper sulfate plating liquid below. The plating conditions are presented below for the treatment process in each working example.

Copper Sulfate Plating Bath Composition

| | | |
|---|---|---|
| Copper sulfate (pentahydrate) | 75 | g/L |
| Sulfuric acid (98%) | 190 | g/L |
| Chloride ions | 50 | mg/L |
| Copper green ST-901AM* | 2 | mL/L |
| Copper Green ST-901BM* | 10 | mL/min |

(*Manufactured by Nippon Rironaru)

### Working Example 1

### Ion Exchange Group Introduction Treatment, Copper Introduction

A copper thin film was formed on a resin base by the treatment process (1) below using Toray-DuPont KAPTON 200H (polyimide resin). After forming the copper thin film, copper sulfate plating was carried out to deposit 25 μm of copper. This composite material was then subjected to hot-pressing for 30 min at 2450 N/cm² and 300° C. to form the composite material of the present invention. The binding strength between the resin base and copper thin film in this composite material was 10.8 N/cm.

TABLE 1
Treatment process 1

16 M H₂SO₄/35% H₂O₂ 0.05 mL/L (CH₃CO)₂O solution; 60° C., 4 min
Water wash; room temperature, 5 min
1 M KOH; room temperature, 5 min
Water wash; room temperature, 1 min
0.1 M CuSO₄; room temperature, 5 min
Water wash; room temperature, 1 min
7 mM NaBH₄; room temperature, 30 min
Water wash; room temperature, 1 min
Self-drying
Copper sulfate plating (Copper Green ST-901) 3 A/dm² 25° C., 45 min
Water wash; room temperature, 2 min
Antirust treatment; room temperature, 1 min
Water wash; room temperature, 2 min
Drying
Hot-pressing

### Working Example 2

### Ion Exchange Group Introduction Treatment, Nickel Introduction

KAPTON 200H, manufactured by Toray DuPont was treated by treatment process (2) below to form a nickel thin film on the resin base. After forming the nickel thin film, copper sulfate plating treatment was carried out to deposit 25 μm of copper. This composite material was then subjected to hot-pressing for 30 min at 300° C. and 2450 N/cm², thus producing the composite material of the present invention. The binding strength between the nickel thin film and resin base in this composite material was 11.8 N/cm.

TABLE 2
Treatment process 2

16 M H₂SO₄/35% H₂O₂ 0.05 mL/L (CH₃CO)₂O solution; 60° C., 4 min
Water wash; room temperature, 1 min
1 M KOH; room temperature, 5 min
Water wash; room temperature, 1 min
0.1 M NiSO₄; room temperature, 5 min
Water wash; room temperature, 1 min
7 mM NaBH₄; room temperature, 30 min
Water wash; room temperature, 1 min
Self-drying
Copper sulfate plating (Copper Green ST-901) 3 A/dm² 25° C., 45 min
Water wash; room temperature, 2 min
Antirust treatment; room temperature, 1 min
Water wash; room temperature, 2 min
Drying
Hot-pressing

### Working Example 3

### Ion Exchange Group Introduction Treatment, Copper Introduction

PIX3400 manufactured Hitachi Kasei DuPont Microsystems (polyimide resin) was applied at 10 μm to an alumina base, and was thermally cured for 30 min at 1 30° C. This base was then treated by treatment process (3) below to form a copper thin film. After forming the copper thin film, the material was subjected to copper sulfate plating to deposit 10 μm of copper. This composite material was then subjected to hot-pressing for 30 min at 300° C. and 2450 N/cm², thus producing the composite material of the present invention. The binding strength between the copper thin film and resin base in this composite material was 11.8 N/cm.

TABLE 3
Treatment process 3

0.5 M KOH; room temperature, 1.5 min
Water wash; room temperature, 1 min
0.05 M CuSO₄; room temperature, 3 min
Water wash; room temperature, 1 min repeated 4 times
5 mM NaBH₄; room temperature, 3 min
Water wash; room temperature, 1 min
Self-drying
Copper sulfate plating (Copper Green ST-901); 3 A/dm², 25° C., 45 min
Water wash; room temperature, 2 min
Antirust treatment; room temperature, 1 min
Water wash; room temperature, 2 min
Drying
Hot-pressing

### Working Example 4

### Ion Exchange Group Introduction Treatment, Nickel-Cobalt Introduction

KAPTON 200H, manufactured by Toray DuPont was treated by treatment process (4) below to form a nickel-cobalt thin film (Ni:Co=1:1) on the resin base. After forming the nickel-cobalt thin film, a copper sulfate plating treatment was carried out to deposit 25 μm of copper. This composite material was then subjected to hot-pressing for 30 min at 300° C. and 2450 N/cm², thus producing the composite material of the present invention. The binding strength between the nickel-cobalt thin film and resin base in this composite material was 12.7 N/cm.

TABLE 4
Treatment process 4

16 M H₂SO₄/35% H₂O₂ 0.05 mL/L (CH₃CO)₂O solution; 60° C., 4 min
Water wash; room temperature, 1 min
1 M KOH; room temperature, 5 min
Water wash; room temperature, 1 min
0.05 M NiSO₄/0.05 M CoCO₄ mixed solution; room temperature, 5 min
Water wash; room temperature, 1 min
7 mM NaBH₄; room temperature, 30 min
Water wash; room temperature, 1 min
Self-drying
Copper sulfate plating (Copper Green ST-901); 3 A/dm², 25° C., 45 min
Water wash; room temperature, 2 min
Antirust treatment; room temperature, 1 min
Water wash; room temperature, 2 min
Drying
Hot-pressing

### Working Example 5

### Ion Exchange Group Introduction Treatment, Silver Introduction

KAPTON 200H, manufactured by Toray DuPont was treated by treatment process 5 below to form a silver thin film on the resin base. After forming the silver thin film, copper sulfate plating treatment was carried out to deposit 25 μm of copper. This composite material was then subjected to hot-pressing for 30 min at 300° C. and 2450 N/cm², thus producing the composite material of the present invention. The binding strength between the silver thin film and resin base in this composite material was 12.7 N/cm.

TABLE 5
Treatment process 5

16 M H₂SO₄/35% H₂O₂ 0.05 mL/L (CH₃CO)₂O solution; 60° C., 4 min
Water wash; room temperature, 1 min
1 M KOH; room temperature, 5 min
Water wash; room temperature, 1 min
0.05 M AgNO₃; room temperature, 5 min
Water wash; room temperature, 1 min
7 mM NaBH₄; room temperature, 30 min
Water wash; room temperature, 1 min
Self-drying
Copper sulfate plating (Copper Green ST-901); 3 A/dm², 25° C., 45 min
Antirust treatment; room temperature, 1 min
Water wash; room temperature, 2 min
Antirust treatment; room temperature, 1 min
Water wash; room temperature, 2 min
Drying
Hot-pressing

### Working Example 6

### Plasma Treatment, Copper Introduction

PIX3400 manufactured Hitachi Kasei DuPont Microsystems (polyimide resin) was applied at 10 μm to an alumina base, and was thermally cured for 30 min at 130° C. This base was then treated by treatment process (6) below to form a copper thin film. After forming the copper thin film, the material was subjected to a copper sulfate plating treatment to deposit 10 μm of copper. This composite material was then subjected to hot-pressing for 30 min at 300° C. and 2450 N/cm², thus producing the composite material of the present invention. The binding strength between the copper thin film and resin base in this composite material was 11.8 N/cm.

TABLE 6
Treatment process 6

0.5 M KOH; room temperature, 1.5 min
Water wash; room temperature, 1 min
Drying
Plasma treatment (Normal-temperature plasma device,
manufactured by Nippon Paint) 80 kV;
electrode separation 2 cm, 10 min treatment
0.05 M-CuSO₄; room temperature, 5 min
Water wash; room temperature, 1 min
5 mM NaBH₄; room temperature, 30 min
Water wash; room temperature, 1 min
Copper sulfate plating (Copper Green ST-901); 3 A/dm², 25° C., 45 min
Water wash; room temperature, 2 min
Antirust treatment; room temperature, 1 min
Water wash; room temperature, 2 min
Drying
Hot-pressing

From the results of Working Examples 1-6 above, it was clear that the composite material manufactured by the method of the present invention has superior binding strength between the resin base and metal thin film.

### Working Example 7

### Change in Binding Strength with Hot-Press Temperature

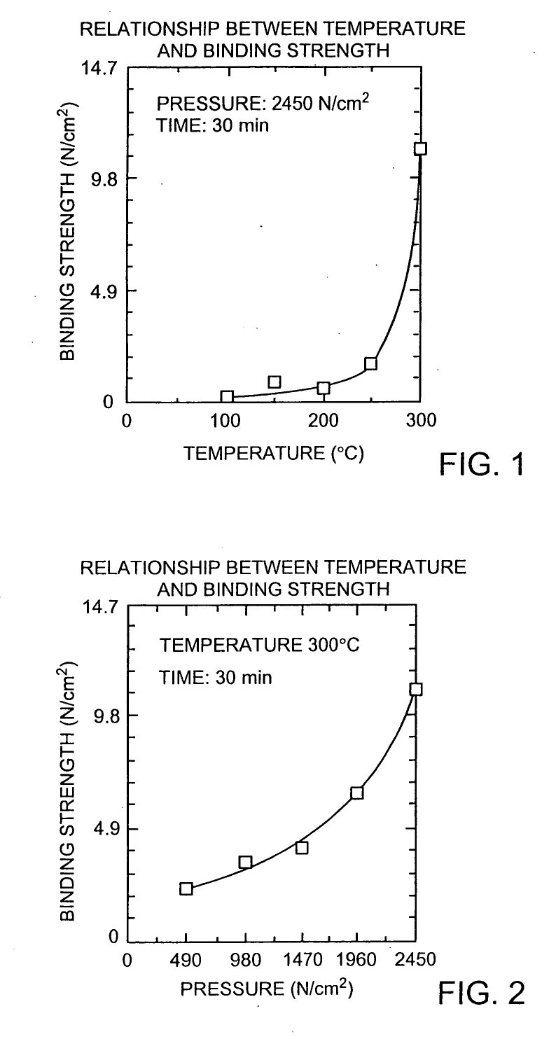

A composite material was obtained under the same conditions as in Working Example 3, with the exception that, among the hot-press parameters, the temperature was varied over 100-300° C. The binding strength between the resin base and metal coating was measured. FIG. 1 is a graph showing the relationship between hot-press temperature represented on the horizontal axis and binding strength represented on the vertical axis.

As is clear from FIG. 1, the binding strength improved with increasing hot-press temperature over a range of 100-300° C.

### Working Example 8

### Change in Binding Strength with Hot-Press Pressure

A composite material was obtained under the same conditions as in Working Example 3, with the exception that, among the hot-press parameters, the pressure was varied over 490-2450 N/cm². The binding strength between the resin base and metal coating was measured. FIG. 2 is a graph showing the relationship between hot-pres pressure represented on the horizontal axis and binding strength represented on the vertical axis.

As is clear from FIG. 2, the binding strength improved with increasing hot-press pressure over a range of 490-2450 N/cm².

### EFFECT OF THE INVENTION

As described above, the composite material of the present invention has improved binding strength between resin base and metal, thus giving excellent binding. The composite material having metal situated on the resin thus can be effectively used in various applications in which good binding is desired.

In addition, the method of the present invention allows for the use of a hot-press method in order to increase binding strength between the metal and resin base, and thus allows for the easy manufacture of composite materials with excellent binding between resin base and metal.

1-7. (canceled)

8. A method for forming a composite material with improved binding strength between resin base and metal, which comprises (1) subjecting a resin base surface to an ion exchange group introduction treatment, (2) treating the surface of said resin base with a liquid containing metal ions in order to introduce metal ions, (3) reducing said metal ions to form a composite material having metal at the surface of the resin base, and (4) hot-pressing the metal and resin base of said composite material.

9. The method according to claim 8, wherein the composite material is subjected to a plating treatment after step (3) and/or after step (4).

10. The method of claim 8 wherein the ion exchange group introduction treatment is carried out by plasma treatment or ion exchange group introduction agent treatment.

11. The method of claim 8 wherein the composite material has a binding strength between the resin base and metal of 5 N/cm or greater.

12. The method of claim 8 wherein the metal is a metal selected from the group consisting of V, Cr, Mn, Fe, Co, Ni, Cu, Ga, As, Se, Mo, Ru, Rh, Pd, Ag, Cd, In, Sb, Te, Os, Ir, Pt, Au, Hg, Pb, Bi and alloys thereof.

13. The method of claim 8 wherein the hot-pressing step is carried out under conditions of a temperature of 100-300° C., a pressure of 490-2450 N/cm² and a time of 5-30 min .
